(19) United States
(12) Patent Application Publication
(10) Pub. No.: US 2014/0136308 A1
(43) Pub. Date: May 15, 2014

(54) ONLINE E-COMMERCE PORTAL FOR RETAILING OF PRODUCT/SERVICE

(71) Applicant: BALAJI GOPALAN, Chennai (IN)

(72) Inventor: BALAJI GOPALAN, Chennai (IN)

(21) Appl. No.: 13/673,381

(22) Filed: Nov. 9, 2012

(51) Int. Cl. G06Q 30/08

(52) U.S. Cl. CPC G06Q 30/08; G06Q 30/0233
USPC 705/14.27

(57) ABSTRACT

Novel method and system for selling product/service in an online store is disclosed. Points are awarded for customer for customer loyalty and which can be used to reduce the price of a product on future purchases. The price will reduce every time a user uses the points to know the current price of the product. The purchase has to be completed within one or more time limits failing which the price will return to the original selling price.

### TECHNICAL FIELD

The present invention relates generally to a method and system for selling product/service from an online store. More particularly, to a method and system for providing options and incentives for the potential buyer to purchase product/service from an online store at a price suitable for the buyer.

### BACKGROUND OF THE INVENTION

Electronic commerce or e-commerce is now fairly established. Offering for sale of product/service on the internet is one for e-commerce, which again is being used by major producers and retailers to sell their product/service. The seller uploads the pictures and details of their product/service along with the prices. Interested buyers can buy the product/services online and the product/service will be shipped to the doorstep of the buyers. This is how e-commerce transactions work. E-commerce transactions are based on complete trust. The more transparent the business model is, the better t is for the e-commerce companies.

Customer retention is one of the most important factors for the success of any company. In highly competitive industries, customer loyalty has utmost importance. The advantage of having a loyal customer base is: cash flow of the company will be good and cost of customer acquisition will be lower.

A variety of methods and systems for offering for sale, selling and buying goods from online stores is known in the art. One method, which is the most common method or regular model, is buying the product/service directly with or without discount the price shown on the web store. The other commonly known methods employ auction models for buying the product/service. There are at least three known models of auction: English auction, Penny auction and Dutch auction. From the point of view of retailers, an English auction can be a little risky as the auction can end at very low values ending up as a loss for the seller. If the selling price of the product/service is very low then the retailer will be forced to ship the product/service. They have no option to cancel the auction after the product/service is sold, without tarnishing their good will.

In an English auction, people have to outbid others bidding on the same product/service to win a product/service. In a model like Regular ecommerce, users buy product/services whereas in an auction website people win product/services. In English auction, let's assume that a user is interested in product/service and has started bidding on it. There is no certainty that he/she will win the auction as even in the last few seconds of the auction, someone can outbid him/her.

In a model like Regular ecommerce model, customers end up paying full price but in an auction website, customers can get great deals.

In a penny auction website, the users can win product/services they want at very low prices but, the probability of winning is very low because of competition and the outcome of the auction can't be controlled. In English auction as more people bid on product/service, the value of the product/service goes up.

In the traditional Dutch auction the seller begins with a high asking price which is lowered until some participant is willing to accept the seller's price. The winning participant pays the last announced price.

The disadvantage of Dutch auctions in view of the participant is that such auctions will start from very high asking prices.

They typically have reserve prices under which the seller might not be willing to sell the product/service. Therefore, the sellers have complete control of the auction and the winning participant may be unable to purchase the item at the desired low rate. The use of a reserve price allows the seller to list the product/service for a lower initial price, but not require that they sell the product/service unless the reserve price is met. If the auction is completed the seller gets at least their reservation price. On the other hand, these auctions are more likely to fail as the participant may not be attracted to participate in auctions with such reserve prices.

In the traditional Dutch auction, the sellers can bring down the price by whichever amount they want. If auction starts at $15000 and reserve price that seller has is $10000, current auction price is $11000, the seller who was reducing the prices by $1000 decrements from $15000 to $11000 can decide to decrease the price by $100 decrements after $11000. It depends on how quickly and desperately he wants to get rid of his inventory. Whereas in the present invention, the decrement value is standard and is set before the auction starts and can't be modified during the auction.

If there are multiple product/services, online Dutch auctions will not stop till all quantity is sold.

The present invention has been proposed to mitigate the risks involved in online auctions and discloses a system and method for selling product/service with reduced risk to the user or participant but also being profitable to the seller.

Therefore, there requires a method and system that combines the advantages of the known e-commerce models and yet entertaining to the user.

### SUMMARY OF INVENTION

It is an object of the invention to provide for a novel computer-implemented method and system for selling product/service online, such as by a computer system having a processor.

It is another object of the invention to retain customers and bring in customer loyalty into online shopping.

It is another object of the invention to provide for an entertainment during online shopping.

It is another object of the invention to increase the revenue of the online retailer.

It is yet another object of the invention to provide for a computer-implemented method and system that gives power to the buyer to decide on the price on which he is willing to buy the product/service.

Accordingly, to meet the objects of the invention, a computer-implemented method of selling a plurality of product/service online, such as by a computer system having a processor, comprising the steps of: providing by the processor of the computer system one or more points for a plurality of potential buyers based on one or more first set of rules; displaying by the processor of the computer system one or more details of the product/service with a unique code on a remote web server accessible by a plurality of client devices through internet; setting by the processor of the computer system a first selling price for the product/service; providing by the processor of the computer system an apparatus for knowing the current price of one or more product/service by a plurality of first set of potential buyers by expending their points, where said current price is less than the first selling price based on the number of points used by one or more potential buyers; providing by the processor of the computer system a first fixed time limit for the plurality of first set of potential buyers on knowing the current price of the product/service to either buy or wait, where on expiry of the first time limit the current price shown to said potential buyers becomes hidden; providing by the processor of the computer system a second time limit for the first potential buyer opting to purchase the product/service before the expiry of the first time limit to complete the purchase and placing on hold the other first set of potential buyers from purchasing the product/service until the expiry of the second time limit; and reverting by the processor of the computer system the current price to the first selling price on completion of the purchase and changing the unique code of the product/service. The said method further comprising the steps of refunding by the processor of the computer system points to the first set of potential buyers whose current price was lower than the first potential buyer opting to purchase the product/service; storing by the processor of the computer system the product/service at a separate virtual location where the purchase is incomplete within the second time limit for a pre-determined second set of rules and allowing one or more potential buyers to opt to purchase the product/service after the second time limit is disclosed.

In yet another embodiment, a computer-implemented method of selling a plurality of product/service online, such as by a computer system having a processor, comprising the steps of: providing one or more points for a plurality of potential buyers based on one or more first set of rules; displaying by the processor of the computer system one or more details of the product/service with a unique code on a remote web server accessible by a plurality of client devices through internet; setting by the processor of the computer system a first selling price for the product/service; providing by the processor of the computer system an apparatus for knowing the current price of one or more product/service by a plurality of first set of potential buyers by expending their points, where said current price is less than the first selling price based on the number of points used by one or more potential buyers; providing by the processor of the computer system a first fixed time limit for the plurality of first set of potential buyers on knowing the current price of the product/service to either buy or wait, where on expiry of the first time limit the current price shown to said potential buyers becomes hidden; providing by the processor of the computer system a second time limit for the first potential buyer opting to purchase the product/service before the expiry of the first time limit to complete the purchase and placing on hold the other first set of potential buyers from purchasing the product/service until the expiry of the second time limit; and reverting by the processor of the computer system the current price to the first selling price on completion of the purchase and changing the unique code of the product/service. The said method further comprising the steps of refunding by the processor of the computer system points to the first set of potential buyers whose current price was lower than the first potential buyer opting to purchase the product/service; storing by the processor of the computer system the product/service at a separate virtual location where the purchase is incomplete within the second time limit for a pre-determined second set of rules and allowing one or more potential buyers to opt to purchase the product/service after the second time limit. The said method further comprising the steps of: providing by the processor of the computer system an apparatus for specifying a maximum bid and a minimum bid on one or more product/service by expending one or more points of a bidder and entering their electronic payment fund transfer details; selling by the processor of the computer system the product/service to the bidder when the current price falls on or below the maximum bid entered by said bidder and precluding other potential buyers from buying the product/service; and calculating by the processor of the computer system the final selling price for the bidder which is the current price minus the difference between the highest and lowest bid set by said bidder multiplied by a multiplier factor.

In accordance with yet another embodiment of the invention, it is disclosed herein, a computer-implemented method of selling a plurality of product/service online, such as by a computer system having a processor, comprising the steps of: providing by the processor of the computer system one or more points for a plurality of potential buyers based on one or more first set of rules; displaying by the processor of the computer system one or more details of the product/service with a unique code on a remote web server accessible by a plurality of client devices through internet; setting by the processor of the computer system a first selling price for the product/service; providing by the processor of the computer system an apparatus for knowing the current price of one or more product/service by a plurality of first set of potential buyers by expending their points, where said current price is less than the first selling price based on the number of points used by one or more potential buyers; providing by the processor of the computer system a first fixed time limit for the plurality of first set of potential buyers on knowing the current price of the product/service to either buy or wait, where on expiry of the first time limit the current price shown to said potential buyers becomes hidden; providing by the processor of the computer system a second time limit for the first potential buyer opting to purchase the product/service before the expiry of the first time limit to provide shipping details and payment mode and placing on hold the other first set of potential buyers from purchasing the product/service until the expiry of the second time limit; reverting by the processor of the computer system the current price to the first selling price upon submitting the shipping details and payment mode and changing the unique code of the product/service; providing by the processor of the computer system a third time limit for buyers opting to use a payment gateway as payment mode to purchase the product/service within which the payment should be completed; storing by the processor of the computer system the product/service at a separate virtual location where the purchase is incomplete within the third time limit for a pre-determined second set of rules and allowing one or more potential buyers to opt to purchase the product/service after the third time limit. The method further comprising the step of refunding by the processor of the computer system points to the first set of potential buyers whose current price was lower than the first potential buyer opting to purchase the product/service.

In accordance with yet another embodiment of the invention, it is disclosed herein, a computer-implemented method of selling a plurality of product/service online, such as by a computer system having a processor, comprising the steps of: providing by the processor of the computer system one or more points for a plurality of potential buyers based on one or more first set of rules; displaying by the processor of the computer system one or more details of the product/service with a unique code on a remote web server accessible by a plurality of client devices through internet; setting by the processor of the computer system a first selling price for the product/service; providing by the processor of the computer system an apparatus for knowing the current price of one or more product/service by a plurality of first set of potential buyers by expending their points, where said current price is less than the first selling price based on the number of points used by one or more potential buyers; providing by the processor of the computer system a first fixed time limit for the plurality of first set of potential buyers on knowing the current price of the product/service to either buy or wait, where on expiry of the first time limit the current price shown to said potential buyers becomes hidden; providing by the processor of the computer system a second time limit for the first potential buyer opting to purchase the product/service before the expiry of the first time limit to provide shipping details and payment mode and placing on hold the other first set of potential buyers from purchasing the product/service until the expiry of the second time limit; reverting by the processor of the computer system the current price to the first selling price upon submitting the shipping details and payment mode and changing the unique code of the product/service; providing by the processor of the computer system a third time limit for buyers opting to use a payment gateway as payment mode to purchase the product/service within which the payment should be completed; storing by the processor of the computer system the product/service at a separate virtual location where the purchase is incomplete within the third time limit for a pre-determined second set of rules and allowing one or more potential buyers to opt to purchase the product/service after the third time limit. The method further comprising the step of refunding by the processor of the computer system points to the first set of potential buyers whose current price was lower than the first potential buyer opting to purchase the product/service. The method further comprising the steps of: providing by the processor of the computer system an apparatus for specifying a maximum bid and a minimum bid on one or more product/service by expending one or more points of a bidder and entering their electronic payment fund transfer details; selling by the processor of the computer system the product/service to the bidder when the current price falls on or below the maximum bid entered by said bidder and precluding other potential buyers from buying the product/service; and calculating by the processor of the computer system the final selling price for the bidder which is the current price minus the difference between the highest and lowest bid set by said bidder multiplied by a multiplier factor.

In accordance with yet another embodiment of the invention, it is disclosed herein, a computer-implemented system for selling a plurality of product/service online, such as by a computer system having a processor, comprising: an apparatus for receiving one or more data of a potential buyer from one or more client devices, creating a unique account for the buyer and storing the data in a remote computer; an apparatus for storing and displaying details of a product/service including its first selling price on a remote computer accessible by one or more client devices; and an engine comprising an apparatus for providing one or more points for a plurality of potential buyers based on one or more first set of rules; and an apparatus for: receiving an input from the user for knowing the current price of one or more product/service by a plurality of first set of potential buyers by expending their points, where said current price is less than the first selling price based on the number of points used by one or more potential buyers; providing a first fixed time limit for the plurality of first set of potential buyers on knowing the current price of the product/service to either buy or wait, where on expiry of the first time limit the current price shown to said potential buyers becomes hidden; receiving an input before the expiry of the first time limit from the first potential buyer opting to purchase the product/service for completing the purchase before the expiry of the second time limit and placing on hold the other first set of potential buyers from purchasing the product/service until the expiry of the second time limit; and reverting the current price to the first selling price on completion of the purchase and refunding points to the first set of potential buyers whose current price was lower than the first potential buyer opting to purchase the product/service. The system further comprises an apparatus for, storing the product/service at a separate virtual location where the purchase is incomplete for a pre-determined second set of rules and allowing one or more first set of potential buyers to purchase the product/service after the completion of the second time limit.

### BRIEF DESCRIPTION OF THE DRAWINGS

Some of the objects of the invention have been set forth above. These and other objects, features, aspects and advantages of the present invention will become better understood with regard to the following description, appended claims and accompanying drawings where:

FIG. 1 is a flow chart depicting one of the embodiments in accordance with the invention.

FIG. 2 is a flow chart depicting one of the embodiments in accordance with the invention.

FIG. 3 is a flow chart depicting one of the embodiments in accordance with the invention.

FIG. 4 is a flow chart depicting one of the embodiments in accordance with the invention.

### DETAILED DESCRIPTION OF THE INVENTION

The present invention will be described with respect to preferred embodiments but the invention not limited thereto but only by the claims. Throughout the specification “potential buyer” is interchangeably used with “user”.

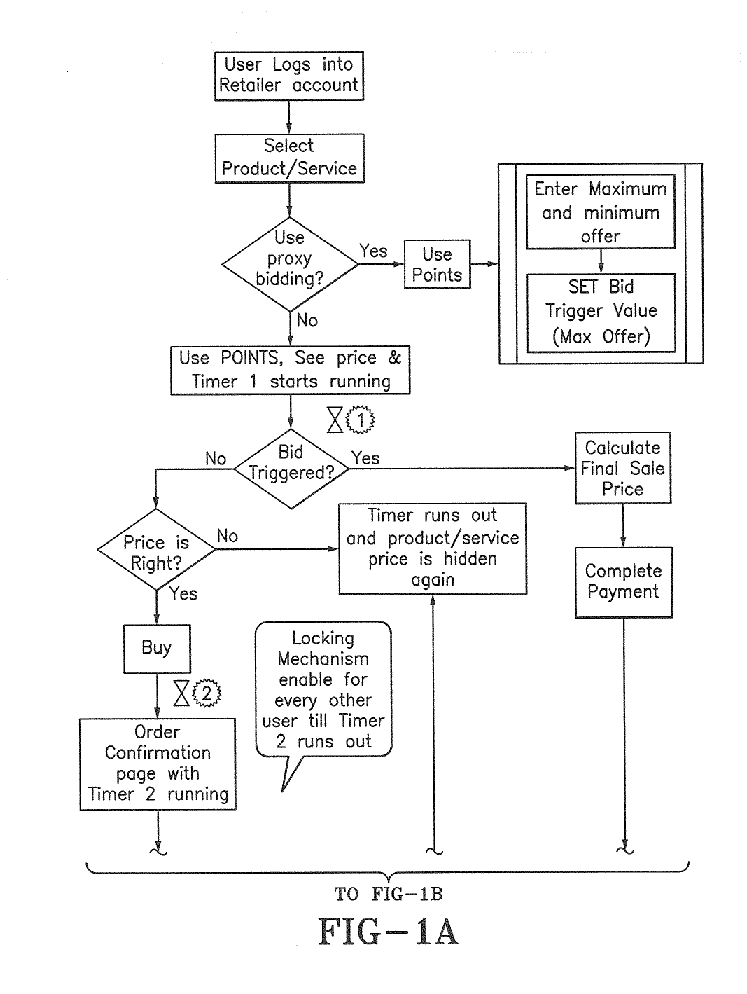

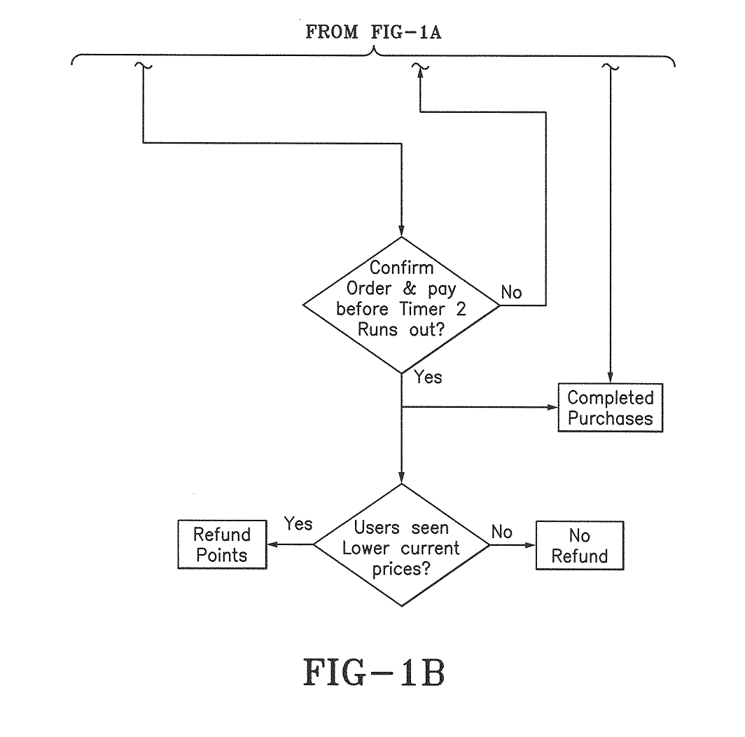

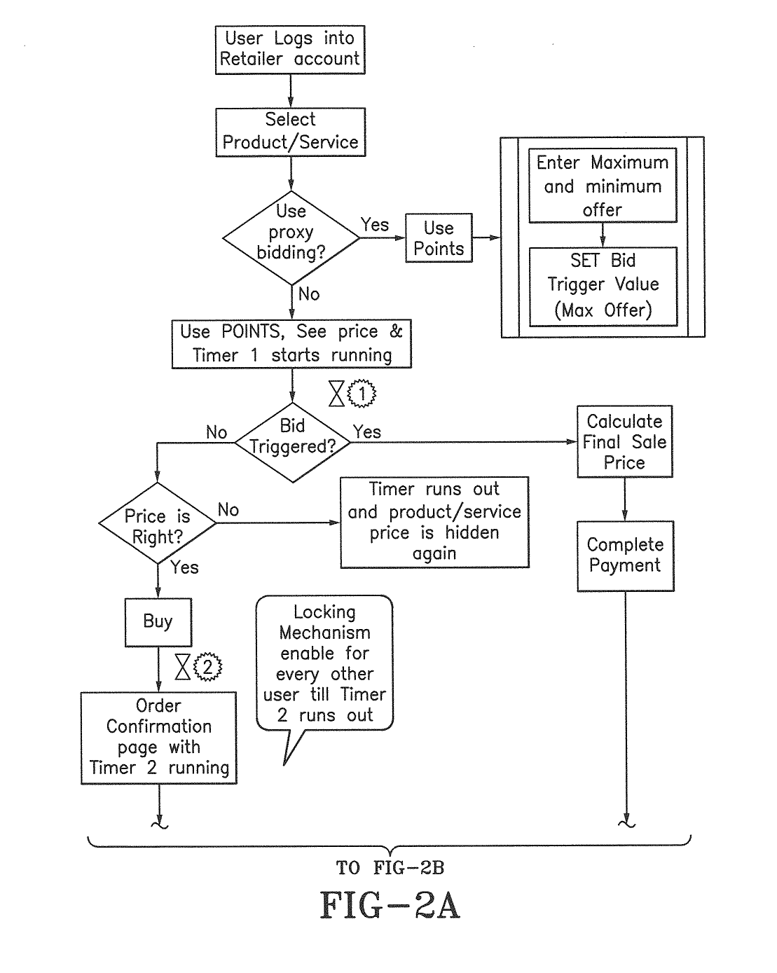

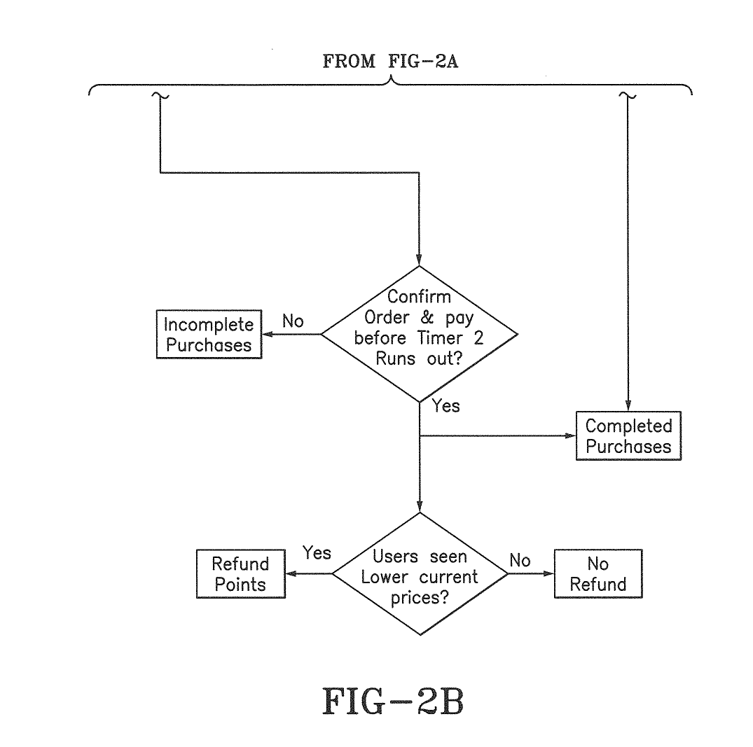

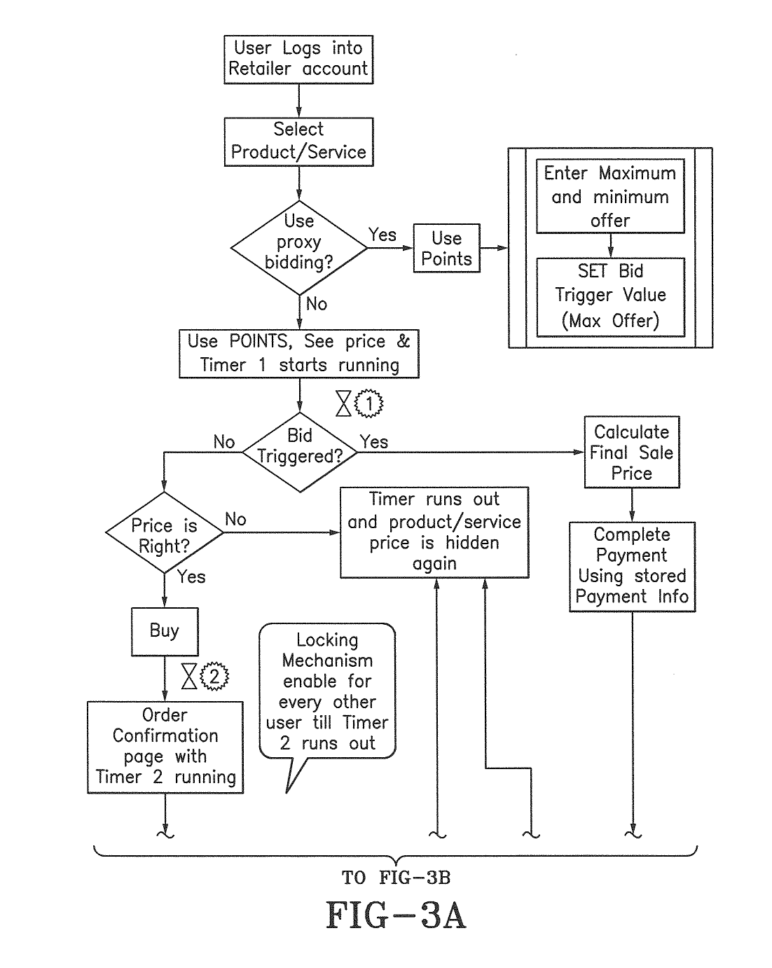

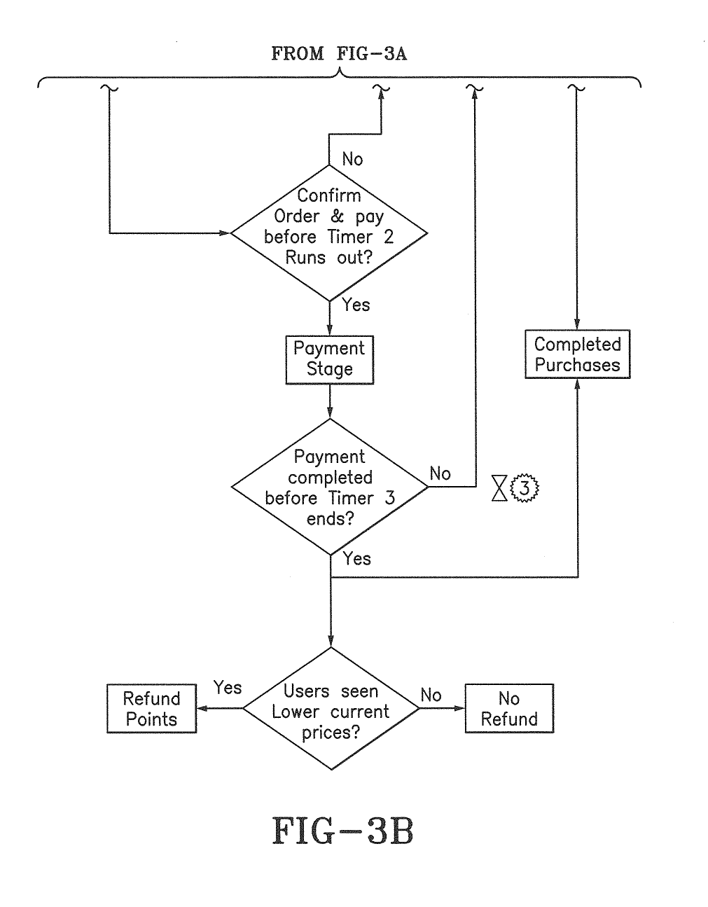

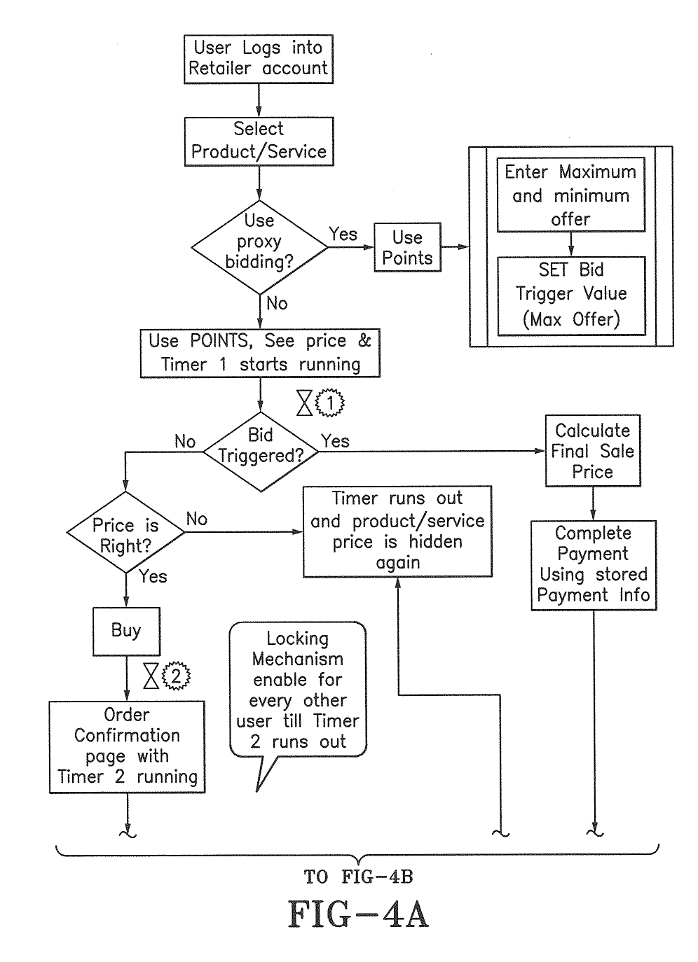

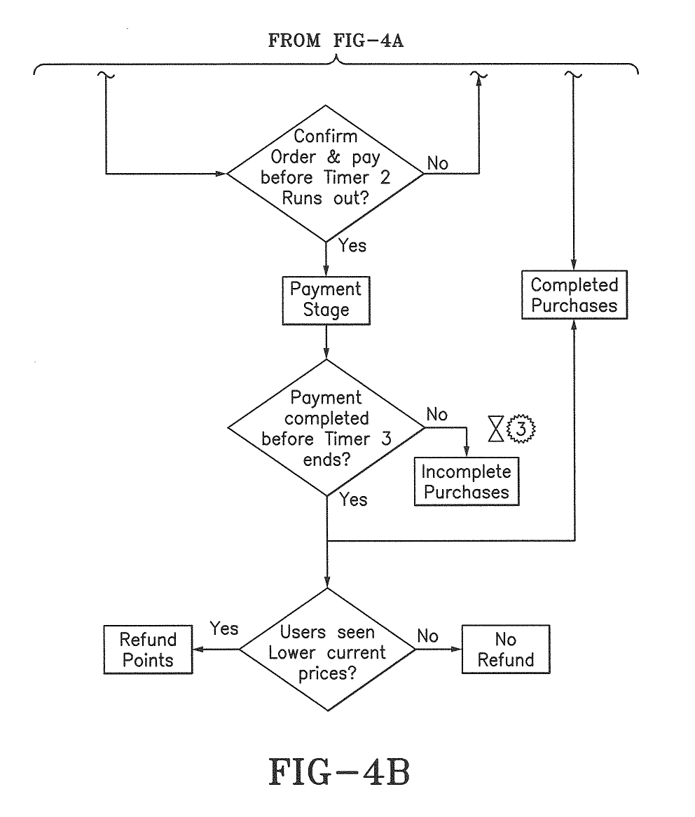

Referring to FIGS. 1 to 4, one or more users create or log into their account on a web store of a retailer. On successful creation of an account, the user is provided with one or more points as an incentive. The points may also be obtained in one or more ways defined by a first set of rules. The product/service to be sold is displayed on the web store with sufficient details about the product/service. The user browses the product/service and selects a product he is interested in. The displayed product/service also has information about its selling price or market price. Near the product/service on display there is a provision for knowing the current price of the product/service. This provision may be a user interface like clicking or pressing a button on the webpage. Using the provision will expend the points in the credit of the user and will reduce the price of the product/service to such an extent of the amount of points which have been used on that product by all users. The monetary value of each point is pre-determined. The number of points consumed will also vary with the type of product. More the number of users use their points on the product/service, lesser the current price of the product/service will become. On clicking the button, a timer, Timer 1 starts running. This is usually 10-15 seconds. If the current price of the product/service suits him, the user has to decide on buying the product/service before the completion of the time limit provided by Timer 1. If he does not choose to buy, the current price will become hidden for him with loss of points. If he chooses to buy, then another provision like clicking a buy button will take him to the webpage to complete the purchase. In addition to it, another timer, Timer 2 will start providing a time limit within which the shipping details of the buyer should be provided. Until the completion of the time limit provided by Timer 2, users other than the user choosing to buy the product/service will be put on hold. On completion of providing required shipping details within Timer 2, the buyer can choose to pay using a payment gateway or cash-on-delivery. If the buyer opts for payment gateway, he will be taken to Timer 3 providing a fixed time limit within which payment should be made. Where the purchase was not completed before the completion of Timer 3 for a second set of rules like power outage, internet connection drop or error in the payment gateway and the like, the product/service will move to incomplete purchase list, where users can continue to use their points to purchase the product.

In another embodiment, the purchase can be completed using the payment gateway within Timer 2 itself without the need for Timer 3.

The first set of rules includes, registering with the seller, purchasing product/service from the seller or purchasing product/service from a third party affiliated with the seller.

The second set of rules includes loss of internet connectivity, incorrect payment gateway credentials, insufficient credit, and insufficient cash in the bank account or the like.

Automatic bids can also be placed by users who do not have the time to check prices at regular intervals. The user who is interested in a product/service can place an automatic bid using the proxy bid device. He needs to enter the maximum and minimum price range that he can spend for that product. The bid agent will take the maximum amount as the first input and once the price drops down and reaches the maximum bid or decreases lower than the maximum bid, the proxy bidding starts. Then the automatic bidder subtracts from the current price of the product, a multiple of the difference between the maximum and minimum values inputted by the user. Then the bid receiving device checks whether there are other proxy bids in same range and if there aren't any, the product is sold to the user and his credit card is charged immediately. The user has to spend a certain amount of points for using proxy bidding. He also has to input his credit card details or other payment details along with the initiation of the proxy bidding device. The multiple with which the current price will be reduced can be customized in the admin panel and also the number of points needed for using the proxy bidding service.

The invention may be further described by describing the various features or components of the invention:

### The Engine

The Engine is an innovative auctioning model wherein the prices of product/service drops down each time a user checks the price. The drop in price also depends on the number of times users have previously checked the price without buying the product/service. Each time a user expends his points, the price of the product/service is reduced by a pre-determined amount which can be set by the retailer.

Once some user buys the product/service, the price is reset to the starting price of the auction. Points are used as options to see the current prices of product/services. The points have a monetary value that can be pre fixed by the retailer. The points are issued to every user by the retailer or seller for one or more conditions like purchasing goods/services or for registering to the website. Points can also be obtained through the retailer's associates or partners for purchasing their goods/services.

Once the users checks to see the price, they will be shown a price and a Timer called Timer 1. Users can buy the product/services at the prices shown before the Timer 1 runs out. Instead of buying product/services at full prices, the users can reduce the prices and buy the product/services at a cheaper rate. Each time a person uses his/her points, price of the product/service drops by a particular amount. Each time a person uses his points, he/she also has the option to buy the product/service at the price shown to him/her.

For initiating the engine, a user checks the price using the points and the current price of the auction is revealed. The points can be used to check current prices of multiple product/services at the same time. Once the user uses his/her points, likes the price and decides to purchase the product/service, he/she can choose to purchase the product/service and a second timer, Timer 2 starts. Now the user has to complete the order before Timer 2 runs out by providing confirmation details like billing and shipping addresses etc. The same Timer 2 is shown for every other user, but cannot proceed further and will have to wait till Timer 2 runs out. No other user can check the price too. This is the lock mechanism.

The user interface may have buttons or any input mechanism for each of these actions like checking the price, bidding, buying and waiting, etc.

Engine has other additional features like the Claim feature and share points that make it very user friendly and fun to use. The claim feature acts as a safety net to users who use points and look for huge discounts. The share points feature lets users transfer points to any other user registered with the system.

The advantage of this auction model is that the outcome of the auction can be controlled and it gives complete buying control to the user during the locked phase i.e. when the Timer 2 is running.

### Registration of the User

A new user must register with the retailer website for using the engine. The registration is very important as the points are added to the email address registered with the retailer. Points can be obtained by the user by one more ways like, registering with his website, buying product/service from the retailer. The motive behind giving points is to make the user into a loyal customer who makes repeat purchases with the retailer. The engine will not function without the user registration. The only thing needed by the website using the engine from the user is his/her email address. All activities like number of points added, past shopping history, claim feature can be traced to the email address registered. The engine will clearly display the number of points owned by the user and every other detail on the profile page of the user account.

### Selection of Product/Service and Use of Points

The user has to select the product/service of his liking. Users can also see prices of multiple product/services at the same time. Multiple prices will be shown to them with multiple timers. Each product/service has a unique product/service code, which will be visible to the users. The engine tracks every product/service based on its product/service codes only. Using the engine, every user can use his points to reduce prices. Points give the user the option to check current prices of product/services. Each act of checking the price costs the user some points. The users get points from retailers for shopping with them. Each point reduces the price of the product/service by a particular predetermined amount which can be changed by the retailer in the Admin control panel of the engine. Only after clicking the button, the lowered price of the product/service in auction can be seen by the user.

### Price

Two prices will be shown to the user. The market price or the selling price which will be the starting price of the auction and the current price of the auction which is revealed after the user uses his points. The current price will always be lower than the market price. The market price is the starting price of the auction.

### Decide to Buy or Wait.

Once the user has used his/her points, two things will happen. The price is shown to him/her and also Timer1 starts running. The time allotted is for the user to decide whether the price is right for him. The user has two options to decide on: to click the buy button if he thinks that the price is right or decide to wait till some more users spend their points and lower the current price of the product/service even more.

If the user decides that the price is right for him/her, he can buy before the Timer 1 runs out. If the user clicks buy, he/she is taken to order confirmation page and a second Timer (Timer 2) starts. In the order confirmation page, he/she has to fill in things like payment method, billing and shipping addresses. Users have a time limit (Timer 2) for doing this. The product/service will be locked and the same Timer2 will be running on every other users' screen with a wait button instead of a buy button. The engine considers the people who click the buy button as serious buyers and will help them make their buying decision without any intervention from other users trying to buy the same product/service at the same time. That is the main reason why Timer 2 is in place. Once the user fills the required information, and clicks confirm order button, he/she is taken to the payment gateway for payment.

If he decides to wait for the price to go even lower, the price disappears after the Timer 1 runs out. The reasoning behind this locking mechanism is that, once the user has checked the price and has clicked the “Buy” button, the system considers him to be a serious buyer. Once this stage is reached, the user is given a particular amount of time and every other user's attempt to buy the product/service will be blocked till the Timer 2 runs out. If the user confirms the order before Timer 2 runs out, then price of the product/service is reset back to the starting price.

The product/service code of the product/service will also change and according to the engine it is new product/service altogether and the auction will start from the market value or selling price of the product/service.

### Timers

Timer 1:

Timer 1 is enabled once a user uses his points to check the price. The duration of this Timer is usually in seconds. The duration of Timer 1 can be changed in the engine by the retailer. The buyer can make the buy/wait decision before Timer 1 ends. Once Timer 1 runs out before the user could click the buy button, the user has to use one or more points to reveal the current price. The number of points required to reveal the current price of the product is set by the retailer and shown to the user.

Timer 2:

Timer 2 is for enabling the lock mechanism. When a potential buyer clicks the buy button before Timer 1 runs out, then Timer 2 is enabled. For all users except for the user who clicked the buy button on the product/service before Timer 1 ran out, the Timer 2 will be shown to them with a WAIT button. They have to wait till the Timer 2 runs out to check price again on the particular product/service. The duration of Timer 2 is in minutes and not seconds. This is slightly longer than the duration of Timer 1. The user needs to enter the shipping address, billing address and payment method before the end of Timer 2 for him to proceed to complete the transaction.

If the payment method is cash on delivery and the user enters all the required details and confirms the order, the transaction is complete and the price of the product/service is reset back to the starting price with a new product/service code.

If the payment method is by credit card, debit card, net banking or any other method other than cash on delivery and the user confirms the order before the end of Timer 2, he is taken to the payment gateway page to complete the payment.

Either way, the product is considered to be sold to all other users if the user has confirmed the order before the end of Timer 2, irrespective of whether the payment will be successful or not.

In another embodiment, the product/service can be purchased using electronic payment gateway in Timer 2 itself.

Timer 3:

Timer 3 is for the user to enter the payment details and he is taken to the payment gateway. If the payment is not completed before the end of Timer 3 or due to some unforeseen reasons, the payment becomes a failure, then the product/service comes to the incomplete purchases page after Timer 3 and people can continue using their points on the product/service, from price last revealed and not from starting price of the auction. Duration of Timer 3 is the longest of all the Timers and usually it is around fifteen minutes.

In another embodiment where the purchase happens in timer 2 itself timer 3 is not required.

### Completed Purchase

After the order confirmation step, if the payment for the product/service is successful, the auction is complete and the product/service reaches the completed purchases page. The product/service code is displayed with the price at which the auction got over. This is used for a tracking purpose. Users who used their points on particular product/service can check the price at which the product/service got sold. This brings in the much needed transparency to the system.

### Incomplete Purchase

After a user completes the order confirmation step, he/she is taken to the payment gateway. If by chance the payment is not successful, the product/service is sent back to the incomplete purchases page after Timer 3 runs out. The product/service leaves the main product/service page and goes to the incomplete purchases and the auction will continue from the price seen by the last user. This page ensures that none of the points used by users go waste due to frivolous actions of any buyer who is not serious about purchasing the product/service.

### Automatic Bid Agent

The Engine uses an innovative kind of a bidding system. In this, the user who opts to engage an automatic bidding agent has to pay a certain number of points to enable the option. The reasoning behind the two offers is that the engine uses the difference between the maximum and the minimum bids to charge the users the points for enabling the automatic bidding option. Also, once the current price in an auction falls In between the maximum and minimum offers by a user using proxy bid agent, the auction is completed. The other use of the maximum and minimum is that the final sale price of the auction is the current value of the auction minus the difference between the highest and the lowest offers, multiplied by a multiplier factor. The reasoning behind this is that users who spent considerable number of points to enable automatic bids should get their returns. Technically it will cost more number of points to set an automatic bid agent where the range between the maximum and minimum offers is higher. The final sale price will also be discounted from the current value using the range between maximum and minimum offers as a main factor.

If the proxy bids cost a fixed number of points, irrespective of the range and if the maximum offer alone is used to calculate the final sale price, then there will be no incentive for people to set up lower ranges for maximum and minimum offers. Normally, the range between the offers should be minimal to benefit the retailer/merchant. Charging lower number of points for setting up bid agents with lower ranges is to incentivise users by charging lower points and hence to influence purchase behaviour.

### Claim Feature:

This enables users to claim back two thirds of their points on any product/service on purchase of the same product/service at full price, provided they have used a minimum number of points on that product/service. For example, if a user A spends twelve points on a product/service and waits for the product/service price to go even lower, and while user A is waiting, User B buys the product/service and price of the product/service is reset; User A can opt to claim eight out of twelve points if he decides to buy the product/service at full price. The cost of the eight points will be reduced from the market price of the product/service. This feature acts as a safety net for serious users.

### Share Points:

Using this share points feature, the users can decide to send and receive points from and to their accounts.

### EXAMPLES

The following non-limiting examples further illustrate and describe the novel embodiments of the invention without limiting the scope of the invention.

### Example 1

User 1 accesses the product/service of his choice and clicks on the interface to know the current market price. The market price or selling price is reduced to the extent of points previously used by various users on the said product/service and shows the current price. A first timer, Timer 1 starts ticking for a fixed time, say 10 seconds. The user may choose to buy the product/service at the reduced price before the completion of the time.

### Example 2

5 users access the same product/service around the same time seeking to know the price by clicking on the interface. The market price or selling price is reduced for each of the 5 users to the extent of points previously used by various users on the said product/service and the interface shows a different current market price for each of the 5 users. Each user has 10 seconds to purchase the product/service. If one of the users, for example User 2, clicks to buy the product/service at the current price displayed in the interface, for example $5,000, he gets the product/service for the current price displayed after paying for the product/service before Timer 3 runs out. The other users for whom the current price displayed in the interface is lower than the current price of the buyer (i.e. $5,000) will get their points refunded to their account. However, for the users whose current displayed prices were more than the current price of the buyer (i.e. $5,000), then for such users the points will be used up and not be refunded.

### Example 3

If user 1 clicks on the button to know the current price of the product/service but does not purchase the product/service within the time limit, the points held by user 1 are used up and the price of the product/service goes down by certain amount. Consider that user 1 repeats this process ‘n’ number of times but still does not purchase the product/service, the price of the product/service comes down further each time. If in the meantime another user, say user 2, accesses the same product/service by clicking on the interface, the current price displayed to the user 2 is much reduced than the starting price due to the act of user 1 and thus user 2 goes for buying the said product/service at the reduced price. In that case the user 1 loses his points he used to bring down the price of the product/service. However, user 1 has an option to claim the product/service for which he used his points at a reduced price than the market price by accessing ‘My claim’ page in his profile. The reduction in the price of product/service for user 1 depends on the number of points used and the amount reduced will be less than the value of points.

### Example 4

Auction starting price for a product is $10000 and current price is $9900 and user A spends 10 points to set automatic proxy bidding and his maximum and minimum offers are $9600 and $8900 respectively. Assuming the current price reaches $9610 as so many other users used their points and brought the price down and user B uses his points and the current price reaches $9590 and user B cannot buy the product, as he triggered a bid agent and also his points will be refunded immediately. User A's proxy bidder gets active and User A will win the product and the final purchase price will be (9590 (current price)−((9600−8900)*X)) where X is the multiplier factor which can be changed in the admin panel. This is the final sale price of the product and user A's credit card will be charged immediately and the product will be offered to him. If there is a user Z who set an automatic bid agent for $9590, still his bid agent will not be active since user A has bid a higher amount. Also if there's another agent who has bid for $9600, then the user with the narrowest gap between his/her maximum and minimum offers win.

### ADVANTAGES OF THE INVENTION

### Gamification

The engine has lots of gamification elements to it. Gamification is the use of game design techniques, game mechanics and game thinking to enhance on game processes. Humans have an innate nature to engage in gaming. Gamification takes advantage of such psychological tendencies of humans to make non game applications and processes more engaging and enhances the loyalty of customers towards a brand.

### Control of Outcome:

The one thing engine is revolutionary is because, in any auction till now, the outcomes can't be controlled by the users. It depends on other users interested in the same product/service at that point of time. The engine has a Timer based mechanism and due to its innovative algorithms, the outcome of any auction happening in a website using the engine can be controlled by the user if he/she wants to.

### Customers Become Loyal:

From the point of view of retailers, an English auction can be a little risky as the auction can end at very low values ending up as a loss for the seller. If the selling price of the product/service is very low then the retailer will be forced to ship the product/services. They have no option to cancel the auction after the product/service is sold.

It gives an option for customers to burn the loyalty points given by the retailers for shopping with them. The value of a retailer's reward program directly depends on how well the points can be redeemed. The great deals that customers get would be a great incentive for them to use the engine again and again and for doing that, the customers need to use their points. The customers can get the points only from the retailer. It will become a healthy cycle and cause a lot of repeat purchases for the retailer.

### Brings Together the Advantages of Both Regular Ecommerce and English Auction Models:

Regular ecommerce models the simplest and most prevalent ecommerce model in the world, but is a bit monotonous. It does not have an entertainment quotient to it. An auction type of model is better because it enables users to get better deals and is much more fun. English auction is a forward auction model. In English auction, users can get lucky and get some great deals. Auctions give users the excitement that a regular ecommerce website can't provide. Auctions have an entertainment quotient to it that regular ecommerce websites lack.

### Exclusive Pricing:

The engine provides customers with exclusive pricing that is just for them. This brings in a lot of exclusivity to the deal that is offered to them. It brings in personalization into the deal and the end users tend to feel special about the price.

Can be applied to various types of product/services and deals:

This is just an auction model and using the model, retailers can sell any kind of product/service. It can be applied to broad categories of product/service as well. The engine offers retailers the flexibility of changing almost every parameter of the mechanism. For selling inexpensive items, the retailers can change the admin setting and make it in such a way that each click of the user costs one point. For expensive items, the system can be changed in such a way that each click costs more than one point, for instance, ten points. Each attempt by users to view current prices on expensive product/service will cost the user ten points instead of one.

### Curiosity Factor:

Using the engine, the prices of product/services keep fluctuating and arouse curiosity in the minds of people about the prices. This curiosity will keep them coming back to the website and will make them shop with the retailer using the engine, to get more points.

This novel invention can be used to create a very loyal customer base. It can be used to make existing customers happy and acquire new customers. It can be used extensively for promotions and the retailers can lower the prices of product/services and market their brand very effectively. The various embodiments of the invention when used wisely can create a lot of secondary revenues for the retailers. It can be used to create new business partnerships with other retailers. It can draw a lot of users to the retailer's business and hence make the value of the retailer's business go up. It will provide the retailers with great competitive advantage.

The points needed by the users have to come from the retailer only and this gives the retailer, complete access to a user base. The users have to buy the product/services of the retailer to get the points and use the engine. The retailer can decide which product/services it has to auction.

The various embodiments in accordance with the principles of the invention are less risky for the retailer to sell product/services than on a platform which runs based on English auction format. This will be a great motivation for retailers willing to auction their product/services. The motivation for buyers to shop in the marketplace is that they get lower prices and great deals. They will also be curious about the current prices of the product/services they like. These will be the factors that will push buyers to purchase from the retailer.

The fun and exciting nature of the invention will be very appealing to young people and the engine can be used to build great brands and make customers happy.

It is the only auction system in the world where the outcome of the auction can be controlled. It is made possible by the use of complex logic and extensive use of Timers. The Timers play a crucial role in negating the hand of luck in the auction process.

It is an innovative auctioning system where the influence of luck on the outcome of any auction is minimal. It is enabled by a lock mechanism which kicks in once a user has clicked the “Buy” button on particular product/service, after spending points. There may be a few other auction systems as well but those are still gambles as they do not have a “Locking Mechanism” that enables users to control the outcomes of auctions.

Using engine, the hand of luck factor is negated. When traffic on the website is high, any other auction site turns into a gambling website and control of outcome of the auction becomes impossible. Humans have an innate nature to control things and engine gives them that. In an English auction, people have to outbid others bidding on the same product/service to win a product/service. In a model like Regular ecommerce, people buy product/services whereas in an auction website people win product/services.

The invention enables consumers to form strategies and work as teams to get great deals. It is a transparent way to transact for the buyers as the process is straight forward and easy to use. The process of buying product/service is very sequential, methodical and transparent. This gives users the comfort and the trust needed to use the website.

To summarize things from the user side, the user registers with retailers and gets points from the retailers, with the motive of getting a great deal on product/service he/she likes, keeping in mind that other users will also be using points on the product/services, he/she is interested in. The user is shown a price once he/she uses his points on the product/service and there will be a Timer 1 that will be running. The user can decide whether the price is right for him/her till the Timer 1 runs out. If he thinks that the price is right for him, he can click the “BUY” button and he is taken to an order confirmation page with Timer 2 running. Till the Timer 2 runs, no other user except for the user who clicked the BUY button will be able to use his/her points on the product/service. The same Timer 2 will be running with a “Wait “button for all other users. Once the user has bought the product/service, the price is reset to initial value and a new auction on the same product/service is started. If the user does not complete the order confirmation page before Timer 2 runs out, the product/service is unlocked to all users of the web site.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

I claim:

1. A computer-implemented method of selling a plurality of product/service online by a computer system having a processor comprising the steps of:
a) providing by the processor of the computer system one or more points for a plurality of potential buyers based on one or more first set of rules;
b) displaying by the processor of the computer system one or more details of the product/service with a unique code on a remote web server accessible by a plurality of client devices through internet;
c) setting by the processor of the computer system a first selling price for the product/service;
d) providing by the processor of the computer system an apparatus for knowing the current price of one or more product/service by a plurality of first set of potential buyers by expending their points, where said current price is less than the first selling price based on the number of points used by one or more potential buyers;
e) providing by the processor of the computer system a first fixed time limit for the plurality of first set of potential buyers on knowing the current price of the product/service to either buy or wait, where on expiry of the first time limit the current price shown to said potential buyers becomes hidden;
f) providing by the processor of the computer system a second time limit for the first potential buyer opting to purchase the product/service before the expiry of the first time limit to complete the purchase and placing on hold the other first set of potential buyers from purchasing the product/service until the expiry of the second time limit; and
g) reverting by the processor of the computer system the current price to the first selling price on completion of the purchase and changing the unique code of the product/service.

2. The method according to claim 1, further comprising the step of refunding by the processor of the computer system points to the first set of potential buyers whose current price was lower than the first potential buyer opting to purchase the product/service.

3. The method according to claim 1 wherein the first set of rules is selected from the group consisting of registering with the seller, purchasing product/service from the seller and purchasing product/service from a third party affiliated with the seller.

4. The method according to claim 1, further comprising the step of:
storing by the processor of the computer system the product/service at a separate virtual location where the purchase is incomplete within the second time limit for a pre-determined second set of rules and allowing one or more potential buyers to opt to purchase the product/service after the second time limit.

5. The method according to claim 4 wherein the second set of rules is selected from the group consisting of loss of internet connectivity, incorrect payment gateway credentials, insufficient credit, and insufficient cash in the bank account.

6. The method according to claim 1, further comprising the steps of:
a. providing by the processor of the computer system an apparatus for specifying a maximum bid and a minimum bid on one or more product/service by expending one or more points of a bidder and entering their electronic payment fund transfer details;
b. selling by the processor of the computer system the product/service to the bidder when the current price falls on or below the maximum bid entered by said bidder and precluding other potential buyers from buying the product/service; and
c. calculating by the processor of the computer system the final selling price for the bidder which is the current price minus the difference between the highest and lowest bid set by said bidder multiplied by a multiplier factor.

7. A computer-implemented method of selling a plurality of product/service online by a computer system having a processor comprising the steps of:
a) providing by the processor of the computer system one or more points for a plurality of potential buyers based on one or more first set of rules;
b) displaying by the processor of the computer system one or more details of the product/service with a unique code on a remote web server accessible by a plurality of client devices through internet;
c) setting by the processor of the computer system a first selling price for the product/service;
d) providing by the processor of the computer system an apparatus for knowing the current price of one or more product/service by a plurality of first set of potential buyers by expending their points, where said current price is less than the first selling price based on the number of points used by one or more potential buyers;
e) providing by the processor of the computer system a first fixed time limit for the plurality of first set of potential buyers on knowing the current price of the product/service to either buy or wait, where on expiry of the first time limit the current price shown to said potential buyers becomes hidden;
f) providing by the processor of the computer system a second time limit for the first potential buyer opting to purchase the product/service before the expiry of the first time limit to provide shipping details and payment mode and placing on hold the other first set of potential buyers from purchasing the product/service until the expiry of the second time limit;
g) reverting by the processor of the computer system the current price to the first selling price upon submitting the shipping details and payment mode and changing the unique code of the product/service;
h) providing by the processor of the computer system a third time limit for buyers opting to use a payment gateway as payment mode to purchase the product/service within which the payment should be completed; and
i) storing by the processor of the computer system the product/service at a separate virtual location where the purchase is incomplete within the third time limit for a pre-determined second set of rules and allowing one or more potential buyers to opt to purchase the product/service after the third time limit.

8. The method according to claim 7, further comprising the step of refunding by the processor of the computer system points to the first set of potential buyers whose current price was lower than the first potential buyer opting to purchase the product/service.

9. The method according to claim 7 wherein the first set of rules is selected from the group consisting of registering with the seller, purchasing product/service from the seller and purchasing product/service from a third party affiliated with the seller.

10. The method according to claim 7 wherein the second set of rules is selected from the group consisting of loss of internet connectivity, incorrect payment gateway credentials, insufficient credit, and insufficient cash in the bank.

11. The method according to claim 7, further comprising the steps of:
a. providing by the processor of the computer system an apparatus for specifying a maximum bid and a minimum bid on one or more product/service by expending one or more points of a bidder and entering their electronic payment fund transfer details;
b. selling by the processor of the computer system the product/service to the bidder when the current price falls on or below the maximum bid entered by said bidder and precluding other potential buyers from buying the product/service; and
c. calculating by the processor of the computer system the final selling price for the bidder which is the current price minus the difference between the highest and lowest bid set by said bidder multiplied by a multiplier factor.

12. A computer-implemented system for selling a plurality of product/service online by a computer system having a processor comprising:
a) an apparatus for receiving one or more data of a potential buyer from one or more client devices, creating a unique account for the buyer and storing the data in a remote computer;
b) an apparatus for storing and displaying details of a product/service including its first selling price on a remote computer accessible by one or more client devices; and
c) an engine comprising an apparatus for providing one or more points for a plurality of potential buyers based on one or more first set of rules; and an apparatus for:
receiving an input from the user for knowing the current price of one or more product/service by a plurality of first set of potential buyers by expending their points, where said current price is less than the first selling price based on the number of points used by one or more potential buyers;
providing a first fixed time limit for the plurality of first set of potential buyers on knowing the current price of the product/service to either buy or wait, where on expiry of the first time limit the current price shown to said potential buyers becomes hidden;
receiving an input before the expiry of the first time limit from the first potential buyer opting to purchase the product/service for completing the purchase before the expiry of the second time limit and placing on hold the other first set of potential buyers from purchasing the product/service until the expiry of the second time limit; and
reverting the current price to the first selling price on completion of the purchase and refunding points to the first set of potential buyers whose current price was lower than the first potential buyer opting to purchase the product/service.

13. The system according to claim 12, wherein said devices are selected from the group of devices consisting of a computer, a tablet, and a mobile phone.

14. The system according to claim 12, wherein the apparatus for storing and displaying details of product/service may be a remote computer accessible by a client device.

15. The system according to claim 12, wherein the first set of rules are selected from the group consisting of registering with the seller, purchasing product/service from the seller and purchasing product/service from a third party affiliated with the seller.

16. The system according to claim 12, further comprising an apparatus for, storing the product/service at a separate virtual location where the purchase is incomplete for a pre-determined second set of rules and allowing one or more first set of potential buyers to purchase the product/service after the completion of the second time limit.

17. The system according to claim 12, wherein the second set of rules are selected from the group consisting of loss of internet connectivity, incorrect payment gateway credentials, insufficient credit and insufficient cash in the bank.
